(19) United States
(12) Patent Application Publication
(10) Pub. No.: US 2013/0060714 A1
(43) Pub. Date: Mar. 7, 2013

(54) DEBT AND DERIVATIVE ALLOCATION FOR GAAP ACCOUNTING RECONCILIATION

(71) Applicants: DANIEL G. GUNDERSON, Coraopolis, PA (US); Russell T. Parker, Alexandria, VA (US); Richard S. Blackley, Leesburg, VA (US)

(72) Inventors: DANIEL G. GUNDERSON, Coraopolis, PA (US); Russell T. Parker, Alexandria, VA (US); Richard S. Blackley, Leesburg, VA (US)

(73) Assignee: Fannie Mae, Washington, DC (US)

(21) Appl. No.: 13/226,954

(22) Filed: Sep. 7, 2011

(51) Int. Cl. G06Q 40/06

(52) U.S. Cl. 705/36 R

(57) ABSTRACT

An apparatus for dividing a balance sheet of a financial instrument from a portfolio level to a sub-portfolio level that includes receiving an asset portfolio and a debt and derivative portfolio of the financial instrument; dividing the asset portfolio and debt and derivative portfolio into a plurality of asset sub-portfolios and debt and derivative sub-portfolios; assigning a portion of each debt derivative sub-portfolio to a specific asset sub-portfolio; allocating a percentage value to each debt and derivative sub-portfolio; calculating a set of financial attributes based upon the allocation percentage; computing a residual error based upon the allocation percentage; and comparing the plurality of residual errors.

### BACKGROUND OF THE INVENTION

1. Field of the Invention

This invention relates to dividing a general investment portfolio into investment sub-portfolios and specifically relates to allocating debt and derivative expenses across specific asset sub-portfolios.

2. Description of the Related Art

When banks and big business look to sub-divide their balance sheet and income statements in a manner consistent with Generally Accepted Accounting Principals (GAAP), the integrity of GAAP statements and the nuances GAAP accounting must be kept intact. Numerous issues arise when dividing the assets, debts and derivatives of a general portfolio. Spitting the assets of the portfolio is straightforward since all accounting entries tied to a specific investment asset can follow the asset to the divided sub-portfolio. However, allocating debts and derivatives is complicated by the fact that debts and derivatives instruments are not necessarily tied to specific investment asset. Instead, the general portfolio contains information on all the debts and derivates of the portfolio without regard to the underlying asset

To divide the debts and derivatives into a sub-portfolio of a specific investment asset, a number of existing solutions exist, none of which are completely accurate. The conventional approach involves allocating the debts and derivatives accruing to percentage. In other words, the ratio of debts and derivatives taken from the general portfolio and moved to the sub-portfolio would equal the ratio the ratio of assets taken from the general portfolio and moved to sub-portfolio. But, this solution is overly simplistic. For example, if one sub-portfolio contained only a few Single Family Mortgages but had a high number of other types of assets, the sub-portfolio may call for high percentage of the debts and derivatives to be assigned to the sub-portfolio. Instead, most of the swaptions (a derivative) are bought to hedge against a Single Family Mortgage prepayment risk and by assigning a ratio of debts and derivatives equal to that of the assets in the sub-portfolio, the sub-portfolio may be assigned to much of the swaption expense relative to the actual number of Single Family Mortgages in the sub-portfolio.

Another mechanism for dividing debts and derivatives into a sub-portfolio of a specific investment asset relies on the Funds Transfer Pricing (FTP) method. This is an established method where a small number of hypothetical debt and derivative instruments are chosen when an asset is purchased to provide hypothetical results over the life of the asset. The problem with this approach is that these hypothetical debt and derivative instruments have no relationship to the actual funding and hedging used to provide the cash of the purchased debt and derivative. In other words, the sum of the sub-portfolios doesn't equal the GAAP results because the FTP method doesn't allocate existing debt and derivatives. The FTP method conjures up synthetic debt for each sub-portfolio without regard to the actual funding of the purchased debt and derivative of each subportfolio.

It would be desirable to provide a secure, efficient and accurate method for allocating debts and derivatives of a general portfolio to a sub-portfolio of a specific investment asset.

It would also be desirable to accommodate the creation of GAAP financial statements for each sub-portfolio.

### SUMMARY OF THE INVENTION

In light of the above issues, the current invention has been undertaken to overcome the difficulty in allocating debt and derivative expenses across specific asset sub-portfolios.

In an embodiment of the current invention, there is provided an apparatus for dividing a balance sheet of a financial instrument from a portfolio level to a sub-portfolio level, the apparatus comprising: receiving means for receiving an asset portfolio and a debt and derivative portfolio of the financial instrument, wherein the asset portfolio and the debt and derivative portfolio contains raw information to support an allocation of assets, debt and derivatives; dividing means for dividing the asset portfolio and debt and derivative portfolio into a plurality of asset sub-portfolios and debt and derivative sub-portfolios; assigning means for assigning each debt derivative sub-portfolio to a specific asset sub-portfolio arriving at a combined asset, debt and derivative sub-portfolio; allocating means for allocating a percentage value to each debt and derivative sub-portfolio in the combined asset, debt and derivative sub-portfolio; calculating means for calculating a set of financial attributes of the combined asset debt and derivative sub-portfolio based upon the allocation percentage assigned to each debt and derivative sub-portfolio; computing means for computing a residual error based upon the allocation percentage and changing the assigned allocation percentage for each debt and derivative sub-portfolio to produce a plurality of residual errors; and comparing means for comparing the plurality of residual errors that converges on a minimum residual error in order to find an ideal allocation percentage.

The apparatus may further comprise a multiplying means for multiplying the ideal risk metric percentage and allocation percentage to the debt and derivative sub-portfolio to produce accounting data for the debt and derivative sub-portfolio.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a block diagram illustrating an example of a debt and derivative allocation system.

FIG. 2A is a block diagram illustrating a company's total assets, debts and derivatives.

FIG. 2B is a spreadsheet illustrating the financial information of a company's balance sheet.

FIG. 3 is a block diagram illustrating dividing the assets, debts and derivatives of a company into an asset portfolio and a debt and derivative portfolio.

FIG. 4 is a block diagram illustrating dividing the assets of an asset portfolio into sub-portfolios.

FIG. 5 is a block diagram illustrating dividing the debts and derivatives of a debt and derivative portfolio into sub-portfolios.

FIG. 6A is a block diagram illustrating combining a specific asset sub-portfolio with the debts and derivatives sub-portfolios that forms three new companies tied to the specific asset.

FIGS. 6B-6D is a spreadsheet illustrating the financial information of the three new companies' balance sheet.

FIG. 7A is block diagram illustrating an iteration of combining a specific asset sub-portfolio with the debts and derivatives sub-portfolios.

FIG. 7B is a spreadsheet illustrating the financial information of Revised Company A's balance sheet.

FIG. 8 is a graph illustrating minimal residual error factors of the specific financial instruments with regards to convexity and duration.

FIG. 9 is a flow diagram illustrating the splitting of a company's total assets, debts, and derivatives.

FIG. 10 is a flow diagram illustrating the assignment and allocation of a plurality of Debt and Derivative Sub-portfolios to a specific Asset Sub-portfolio and the iterative calculation of certain financial attributes.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

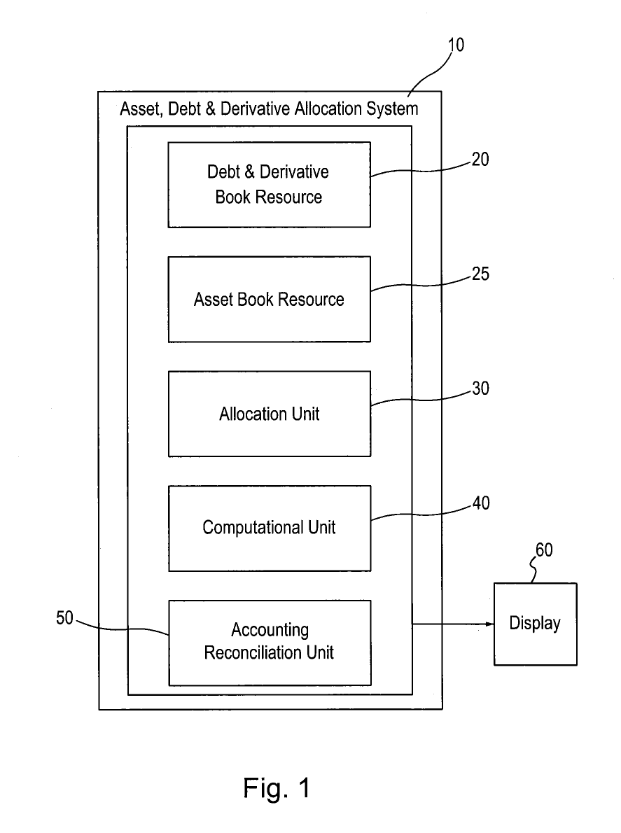

FIG. 1 is a block diagram illustrating an example of an asset, debt and derivative allocation system 10 and illustrates the functional components for allocating debts and derivatives across an asset sub-portfolio. The system may be, for example, a mechanism for manipulating the allocation of debts and derivatives of a specific asset and displaying the resulting allocation on display 60. In addition to displaying the resulting allocation on display 60, the asset, debt and derivative allocation system 10 also includes reconciliation of accounting requirements among disparate asset sub-portfolios.

The Debt and Derivative Book Resource 20 contains all the financial information regarding the debt and derivatives of a company's balance sheet. The Asset Book Resource 25 contains all the financial information regarding the asset of a company's balance sheet. This financial information is manipulated by the Allocation Unit 30 and Computational Unit 40 to split the assets, debts, and derivatives of a portfolio into sub-portfolios by product class or financial instrument. Accounting reconciliation consistent with GAAP is then performed on each sub-portfolio by Accounting Reconciliation Unit 50. The GAAP debt and derivative results for each asset may then be displayed on display 60. Note that the Accounting Reconciliation Unit 50 allows the GAAP financial statements of the total Debt and Derivative Book Resource 20 to be split into sub-statements that represent the GAAP statements of an asset sub-portfolio by multiplying the GAAP account balances of the separate debt and derivative sub-portfolios by the appropriate percentage allocation for the financial instrument in each sub-portfolio.

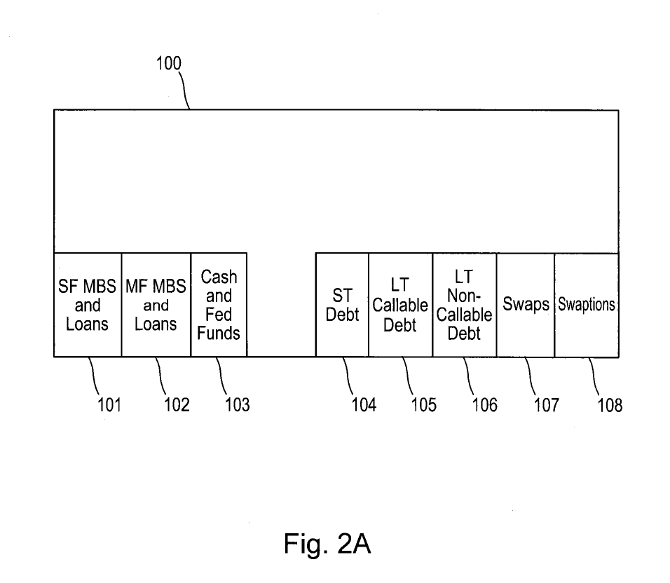

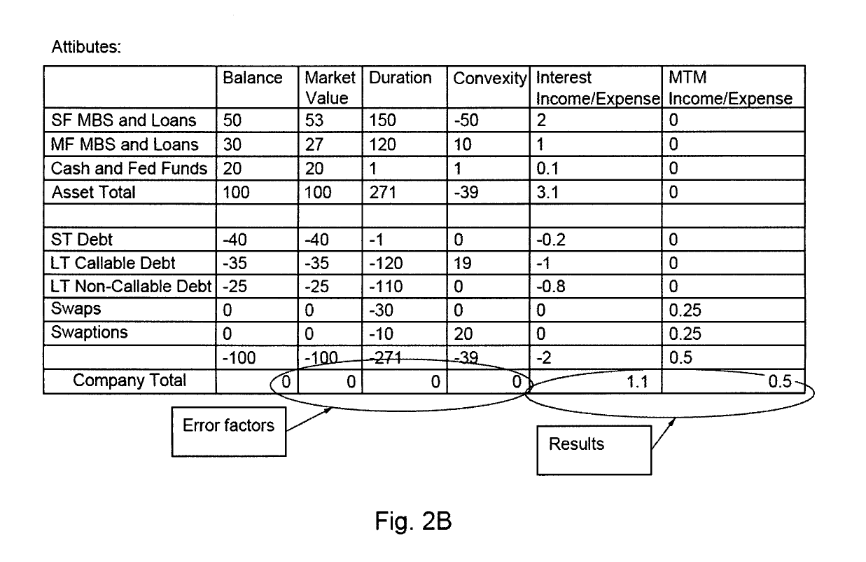

FIG. 2A is a block diagram illustrating a company's total assets, debts and derivatives. The total assets, debts and derivatives of Company 100 are separated as buckets of like instruments or product classes. For instance, the assets relating to Single Family Mortgage Backed Securities (SF MBS) and Loans 101, Multi Family Mortgage Backed Securities (MF MBS) and Loans 102, Cash and Fed Funds 103 are parsed out from the debts and derivatives relating to Short Term (ST) Debts 104, Long Term (LT) Callable Debt 105, LT Non-Callable Debt 106, Swaps 107, and Swaptions 108.

Note that other types of assets, debts, and derivatives can be separated out in this manner Other assets of buckets of like instruments or product classes may include but are not limited to: Jumbo MBS, Hybrid/ARM, Agency CMO, MF CMO, SF Jumbo Loans, SF Hybrid ARM, SF Reverse, MF Jumbo Loans, MF Hybrid ARM, or MF Reverse. Other debts and derivatives of buckets of like instruments or product classes may include but are not limited to: Discount Notes, Fixed Rate Bullet Debts, Floating Rate Bullet Debts, Zero Coupon Bonds, Subordinated Debts, Callable Debt, Receive Fixed Swaps, Pay Fixed Swaps, Cancelable Fixed Swap, Received Fixed Swaptions, or Pay Fixed Swaptions.

FIG. 2B is a spreadsheet illustrating the financial information of a company's balance sheet. The company's balance sheet depicts certain financial attributes of the total assets, debts and derivatives of that company. The financial attributes or characteristics may include: Market Value, Duration, and Asset Convexity, Interest Income/Expense, MTM Income/Expense. Other types of financial characteristics such as key rate durations, vega, etc., may also be identified.

The total assets are divided by a percentage Balance that when added together equals 100%. For example, the SF MBS and Loans Balance is 50%, MF MBS and Loans Balance is 30%, and the Cash and Fed Funds Balance is 20%, totaling one hundred percent. Similarly, the total debts and derivatives are divided by a percentage that when added together equals 100%. For example, the ST Debt Balance is −40%, LT Callable Debt Balance is −35%, the LT Non-Callable Debt Balance is −25%, the Swaps Balance is 0%, and the Swaptions Balance is 0% totaling one hundred percent.

Along with identifying and calculating the Balance for each asset, debt, derivative product class financial attribute, Market Value, Duration, and Asset Convexity, Interest Income/Expense, MTM Income/Expense may also be calculated.

By subtracting the difference between the financial attributes of the total assets and the total debts and derivatives, residual error factors and results may be calculated for each financial attribute. This can readily be seen in the last row of the spreadsheet in FIG. 2B. Note in FIG. 2B, the company in question has no residual error factors for these financial attributes. In addition, the GAAP earnings can be accounted for Company 100 based upon the Interest income/expense and MTM income/expense.

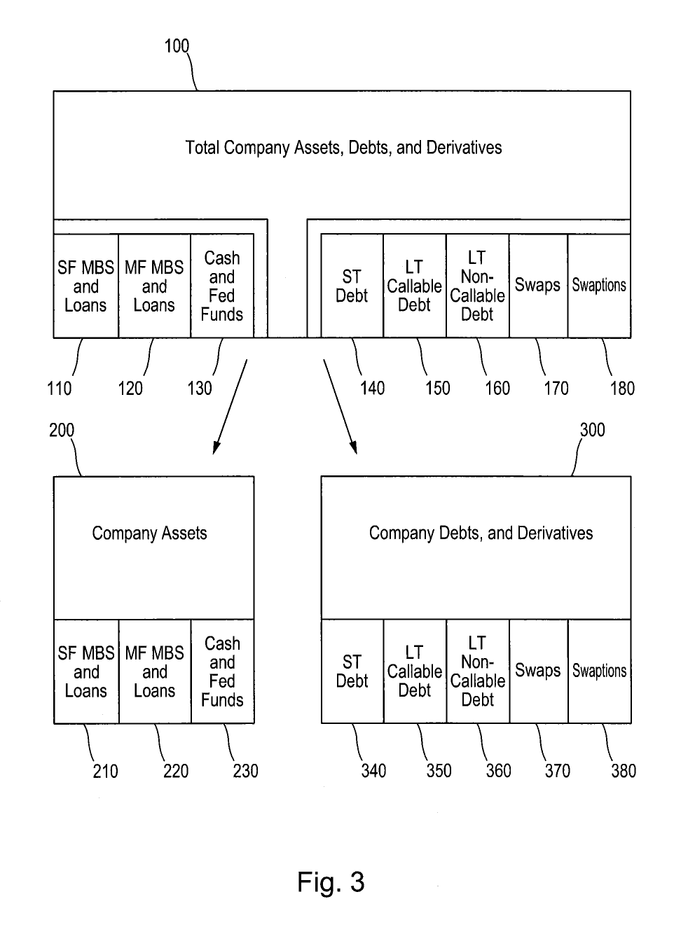

FIG. 3 is a block diagram illustrating dividing the assets, debts and derivatives of a company into an asset portfolio and a debt and derivative portfolio. As discussed above, the total assets, debts and derivatives of Company 100 are separated as buckets of like instruments or product classes. In other words, the assets of Company 100 are parsed out from the debts and derivatives of Company 100.

After this separation, the assets, debts and derivatives of Company 100 are split. The assets are placed in Asset Portfolio 200 while the debts and derivatives are placed in Debt and Derivative Portfolio 300. Asset Portfolio contains SF MBS and Loans 210, MF MBS and Loans 220, and Cash and Fed Funds 230. Debt and Derivative Portfolio 300 contains ST Debt 340, LT Callable Debt 350, LT Non-Callable Debt 360, Swaps 370, and Swaptions 380. Both the Asset Portfolio 200 and the Debt and Derivative Portfolio may include more product classes, as needed.

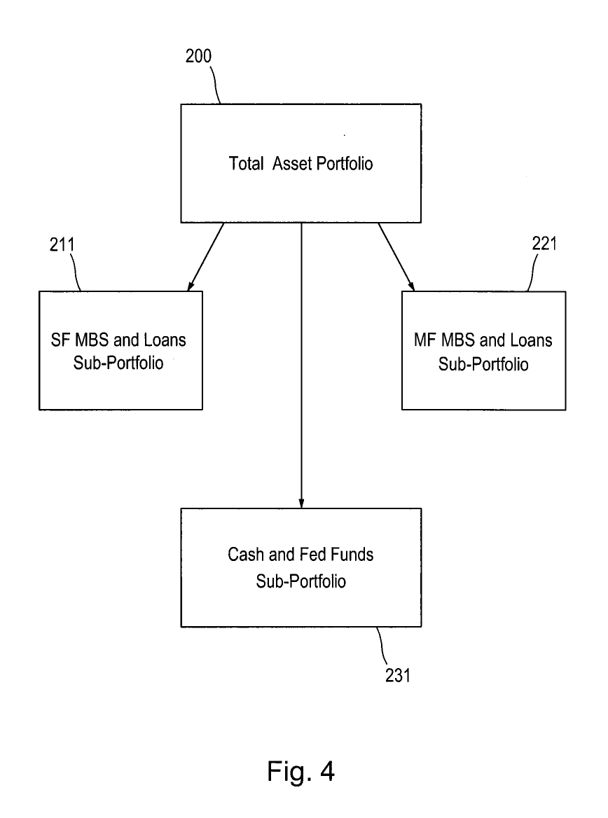

FIG. 4 is a block diagram illustrating dividing the assets of an asset portfolio into asset sub-portfolios. In FIG. 4, Asset Portfolio 200 is split into three Asset Sub-portfolios 211, 221, and 231. Note that the Asset Portfolio 200 may be split in more asset sub-portfolios as needed. The assets in Asset Portfolio 200 are utilized for funding and risk management and can be tied to a specific financial instrument or product class. In FIG. 4, Asset Portfolio 200 is carved up as SF MBS and Loans Sub-portfolio 211, MF MBS and Loans Sub-portfolio 221, and Cash and Fed Funds Sub-portfolio 231.

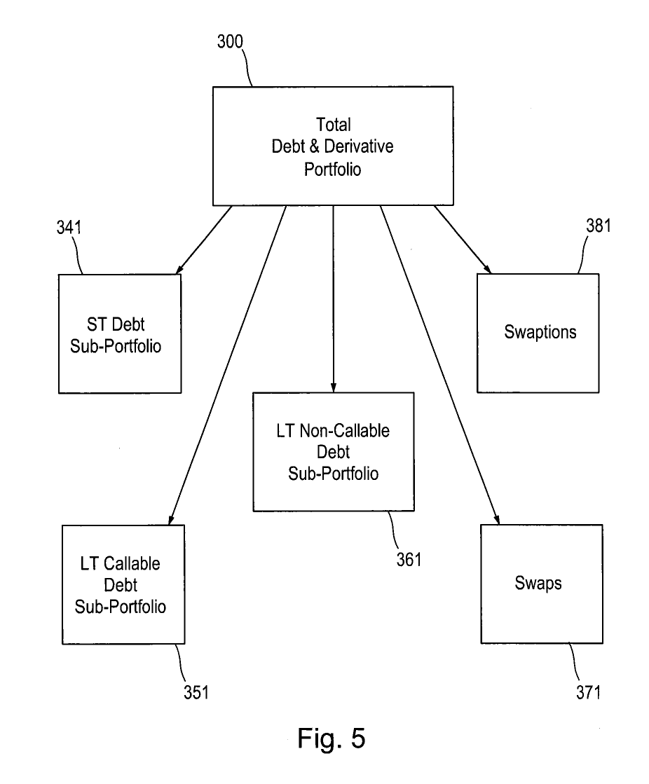

FIG. 5 is a block diagram illustrating dividing the debts and derivatives of a debt and derivative portfolio into debt and derivative sub-portfolios. In FIG. 5, Debt and Derivative Portfolio 300 is split into five Debt and Derivative Sub-portfolios 341, 351, 361, 371, and 381. Note that the Debt and Derivative Portfolio 300 may be split in more asset sub-portfolios as needed. The debts and derivatives in Debt and Derivative Portfolio 300 are utilized for funding and risk management and can be tied to a specific financial instrument or product class. In FIG. 4, Debt and Derivative Portfolio 300 is carved up as ST Debt Sub-portfolio 341, LT Callable Debt Sub-portfolio 351, LT Non-Callable Debt Sub-portfolio 361, Swaps Sub-portfolio 371, and Swaptions Sub-portfolio 381.

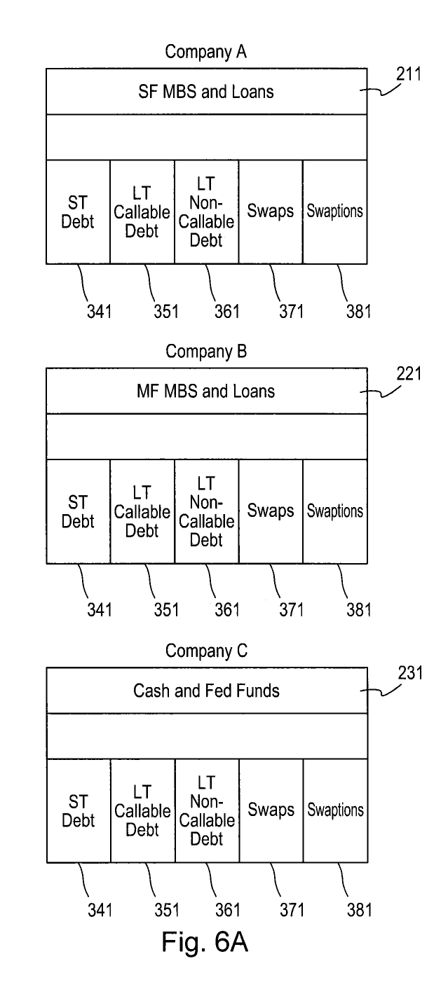

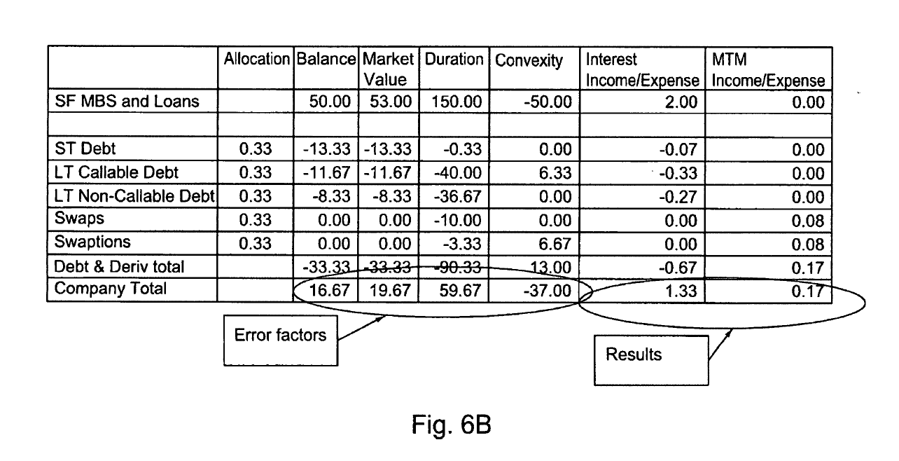

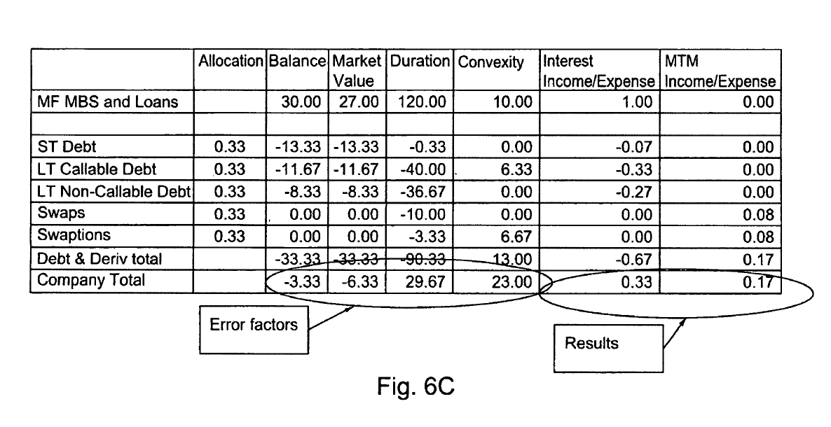

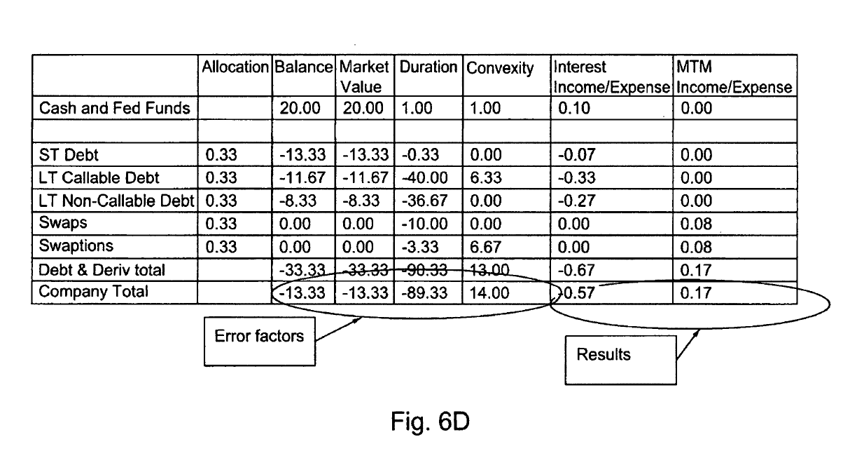

FIG. 6A is a block diagram illustrating combining a specific asset sub-portfolio with the debts and derivatives sub-portfolios that forms three new companies tied to the specific asset. In essence, three new companies can be formed, each having a specific asset sub-portfolio and a slice of all the debt and derivative sub-portfolios.

Company A incorporates the assets of the SF MBS and Loans Sub-portfolio 211 in addition to the debts and derivatives of ST Debt 341, LT Callable Debt 351, LT Non-Callable Debt 361, Swaps 371, and Swaptions 381 Sub-portfolios. Company B incorporates the assets of the MF MBS and Loans Sub-portfolio 221in addition to the debts and derivatives of ST Debt 341, LT Callable Debt 351, LT Non-Callable Debt 361, Swaps 371, and Swaptions 381 Sub-portfolios. Company C incorporates the assets of the Cash and Fed Funds Sub-portfolio 231 in addition to the debts and derivatives of ST Debt 341, LT Callable Debt 351, LT Non-Callable Debt 361, Swaps 371, and Swaptions 381 Sub-portfolios.

Note that the though the asset sub-portfolios are divvied up between each company, each of debt and derivative sub-portfolios are divided equally among Companies A-C. For instance, one third of the ST Debt Sub-portfolio 341 is incorporated into Company A, one third is incorporated into Company B, and one third is incorporated into Company C. The same holds true for the LT Callable Debt 351, LT Non-Callable Debt 361, Swaps 371, and Swaptions 381 Sub-portfolios.

FIGS. 6B-6D are spreadsheets illustrating the financial information of the three new companies' balance sheet. FIG. 6B illustrates the financial information for Company A's balance sheet. FIG. 6C illustrates the financial information for Company B's balance sheet. FIG. 6D illustrates the financial information for Company C's balance sheet. The companies' balance sheet depicts certain financial attributes of the total assets, debts and derivatives of that company.

Since FIG. 6B represents Company A, the Balance of the corresponding asset sub-portfolio (SF MBS and Loans) is 50%. However, since each debt and derivative sub-portfolio has been equally allocated among Companies A-C, the debts and derivatives in FIG. 6B will total 33.33%. Here, the ST Debt Balance is −13.33%, LT Callable Debt Balance is −11.67%, the LT Non-Callable Debt Balance is −8.33%, the Swaps Balance is 0%, and the Swaptions Balance is 0% totaling −33.33%.

Along with identifying and calculating the Balance for Company A, the Market Value, Duration, Asset Convexity, Interest Income/Expense, and MTM Income/Expense may also be calculated for Company A.

The residual error factors can be calculated for each financial attribute by subtracting the difference between the asset financial attribute from the total debts and derivative financial attributes. For FIG. 6B, the Residual Error Factor for the Balance of Company A is 16.67, the Residual Error Factor for the Market Value of Company A is 19.67, the Residual Error Factor for the Duration of Company A is 59.67, and the Residual Error Factor for the Convexity of Company A is −37. In addition, the GAAP earnings can be accounted for Company A based upon the Interest income/expense and MTM income/expense.

Since FIG. 6C represents Company B, the Balance of the corresponding asset sub-portfolio (MF MBS and Loans) is 30%. However, since each debt and derivative sub-portfolio has been equally allocated among Companies A-C, the debts and derivatives in FIG. 6B will total 33.33%. Here, the ST Debt Balance is −13.33%, LT Callable Debt Balance is −11.67%, the LT Non-Callable Debt Balance is −8.33%, the Swaps Balance is 0%, and the Swaptions Balance is 0% totaling −33.33%.

Along with identifying and calculating the Balance for Company A, the Market Value, Duration, Asset Convexity, Interest Income/Expense, and MTM Income/Expense may also be calculated for Company B.

The residual error factors can be calculated for each financial attribute by subtracting the difference between the asset financial attribute from the total debts and derivative financial attributes. For FIG. 6C, the Residual Error Factor for the Balance of Company B is −3.33, the Residual Error Factor for the Market Value of Company B is −6.33, the Residual Error Factor for the Duration of Company B is 29.67, and the Residual Error Factor for the Convexity of Company B is 23. In addition, the GAAP earnings can be accounted for Company C based upon the Interest income/expense and MTM income/expense.

Since FIG. 6D represents Company C, the Balance of the corresponding asset sub-portfolio (Cash and Fed Funds) is 20%. However, since each debt and derivative sub-portfolio has been equally allocated among Companies A-C, the debts and derivatives in FIG. 6B will total 33.33%. Here, the ST Debt Balance is −13.33%, LT Callable Debt Balance is −11.67%, the LT Non-Callable Debt Balance is −8.33%, the Swaps Balance is 0%, and the Swaptions Balance is 0% totaling −33.33%.

Along with identifying and calculating the Balance for Company C, the Market Value, Duration, Asset Convexity, Interest Income/Expense, and MTM Income/Expense may also be calculated for Company C.

The residual error factors can be calculated for each financial attribute by subtracting the difference between the asset financial attribute from the total debts and derivative financial attributes. For FIG. 6D, the Residual Error Factor for the Balance of Company C is −13.33, the Residual Error Factor for the Market Value of Company C is −13.33, the Residual Error Factor for the Duration of Company C is −89.33, and the Residual Error Factor for the Convexity of Company C is 14. In addition, the GAAP earnings can be accounted for Company C based upon the Interest income/expense and MTM income/expense.

The mismatch between the residual errors factors for Companies A-C as compared to the residual error factors for the original Company is quite apparent. By simply allocating a third of all debt and derivative to this asset cut we end up with not enough debt or to much debt relative to the asset for Companies A-C. Consequently, the Results (Interest Income/Expense and MTM income/Expense) don't help us in evaluating the profitability of the Companies A-C.

Obviously using 33% for all the allocations resulted in three companies with mismatched balances, market values, convexity, and duration. It isn't realistic to have a sub-portfolio with $50 of assets but only $33 of debts and derivatives regarding Company A. Since we started with a company that was balanced we should be able to vary the allocations and come up with three splits of the debt and derivatives that create three balanced companies. Note that this isn't a necessary constraint, it may be possible to create one balanced sub-portfolio from a company that isn't balanced.

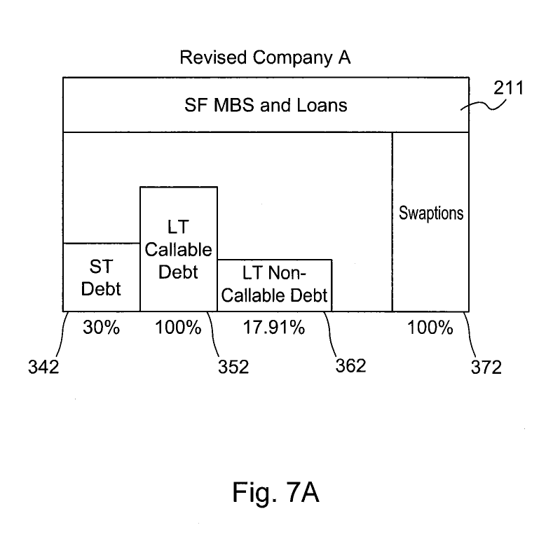

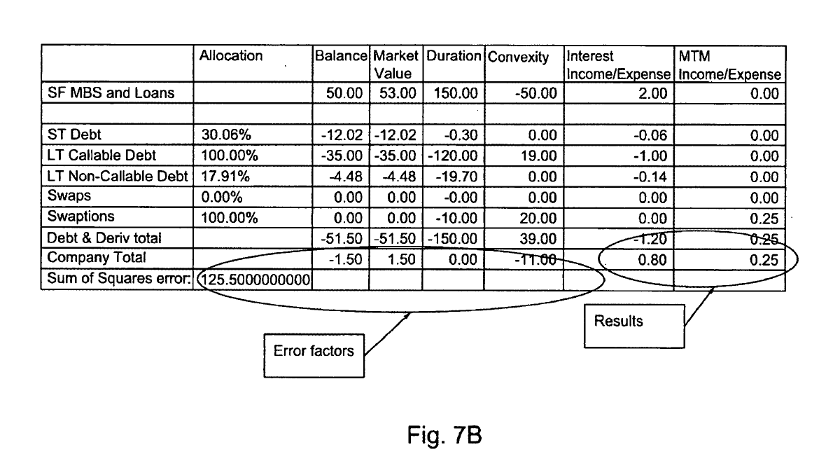

FIG. 7A is block diagram illustrating the final iteration of combining a specific asset sub-portfolio with the debts and derivatives sub-portfolios for the SF MBS and Loans Asset Sub-portfolio 211. In other words, FIG. 7A illustrates the final iteration of Company A by changing the debts and derivatives allocation that produces minimal residual error factors. Though FIG. 7 involves on Company A, the same types of calculations and allocation can be prepared for Companies B-C. Though the calculations and the allocations prepared for Companies A-C is determined by an iterative process, they can also be determined via a algebraic process.

Similar to FIG. 6A, Revised Company A incorporates the assets of the SF MBS and Loans Sub-portfolio 211 in addition to the debts and derivatives sub-portfolios. However, the percentages of the debts and derivatives allocated to Revised Company A are different that those allocated to Company A. The allocation of ST Debt 342 Sub-portfolio is 30%, LT Callable Debt 352 Sub-portfolio is 100%, LT Non-Callable Debt 362 Sub-portfolio is 17.91%, Swaps 372 Sub-portfolio is 0%, and Swaptions 382 Sub-portfolio is 100%.

FIG. 7B is a spreadsheet illustrating the financial information of Revised Company A's balance sheet which depicts certain financial attributes of the total assets, debts and derivatives of Revised Company A. The financial attributes or characteristics include: Allocation, Balance, Market Value, Duration, and Asset Convexity, Interest Income/Expense, MTM Income/Expense.

Since FIG. 7B represents Revised Company A, the Balance of the corresponding asset sub-portfolio (SF MBS and Loans) is 50%. The debt and derivative sub-portfolio has been allocated to Revised Companies A as follows: ST Debt 342 is 30%, LT Callable Debt 352 is 100%, LT Non-Callable Debt 362 is 17.91%, Swaps 372 is 0%, and Swaptions 382 is 100%. Accordingly, the ST Debt Balance is −12.02%, LT Callable Debt Balance is −35%, the LT Non-Callable Debt Balance is −4.48%, the Swaps Balance is 0%, and the Swaptions Balance is 0% totaling −51.5%.

Along with identifying and calculating the Balance for Revised Company A, the Market Value, Duration, Asset Convexity, Interest Income/Expense, and MTM Income/Expense may also be calculated for Company A.

The residual error factors can be calculated for each financial attribute by subtracting the difference between the asset financial attribute from the total debts and derivative financial attributes. For FIG. 7A, the Residual Error Factor for the Balance of Revised Company A is −1.5, the Residual Error Factor for the Market Value of Revised Company A is 1.5, the Residual Error Factor for the Duration of Revised Company A is 0, and the Residual Error Factor for the Convexity of Revised Company A is −11. In addition, the GAAP earnings can be accounted for Revised Company A based upon the Interest income/expense and MTM income/expense.

Note that the sum of the squares of the errors is not zero. That's ok, this is as close as the iterative process can get. There isn't a set of allocations that result in zero error for this case. As such, this results in a meaningful Income and Expense values regarding the SF MBS and Loans Asset Sub-portfolio 2. The income and expense for the SF MBS and Loans Asset Sub-portfolio 211 can be looked at in order to see which contributes the most to GAAP earnings.

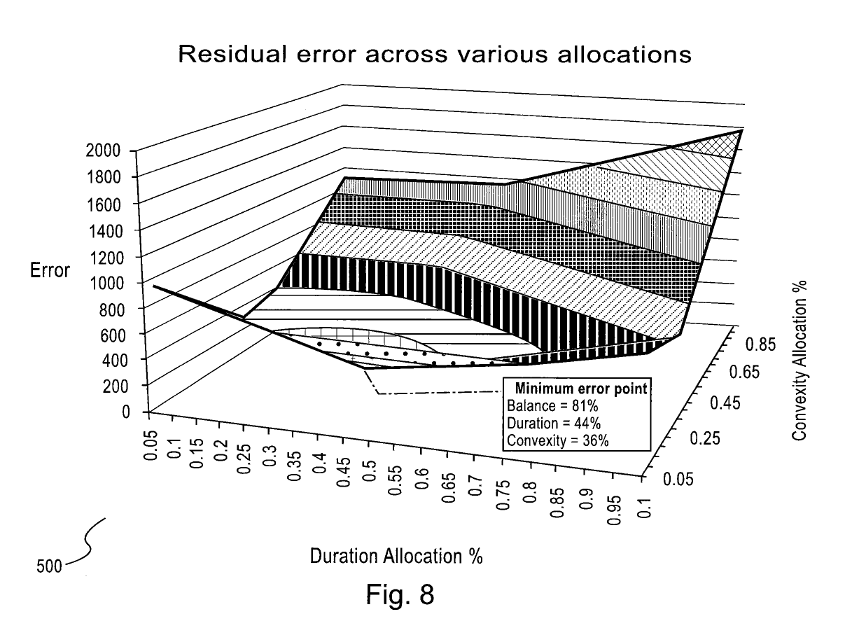

FIG. 8 is a graph 500 illustrating minimal residual error factors of the specific financial instruments with regards to convexity and duration. After the iterations of a specific asset sub-portfolio (relative to the debt and derivative sub-portfolios) is used to calculate the minimum residual error, market value, duration, and convexity, there is a need to illustrate how the convexity percentage and duration percentage relate to the residual for the iterations. Graph 500 illustrates the range of error with respect duration allocation percentage and the convexity allocation percentage. Moreover, graph 500 specifically displays the minimum residual error point across various allocations.

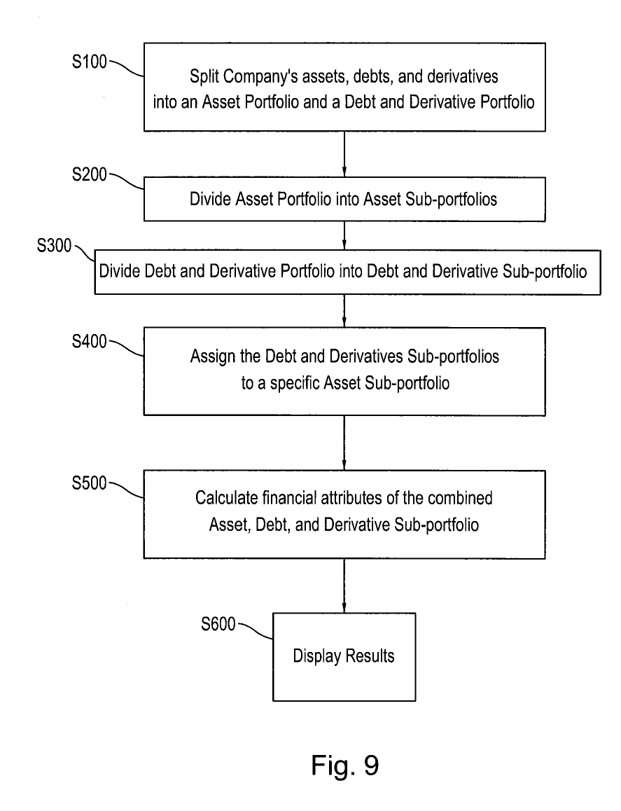

FIG. 9 is a flow diagram illustrating the splitting of a company's total assets, debts, and derivatives. At 5100, a company's assets, debts, and derivatives are split into an Asset Portfolio and a Debt and Derivative Portfolio.

Step S200 divided the Asset Portfolio into Asset Sub-portfolios along bucket of like instruments or product classes. The Asset Sub-portfolios are categorized by product class such as SF MBS and Loans, MF MBS and Loans, and Cash and Fed Funds. Step S300 divides the Debt and Derivative Portfolio into Debt and Derivative Sub-Portfolios along bucket of like instruments or product classes. The Debt and Derivative Sub-portfolios are categorized by product class such as ST Debt, LT Callable Debt, LT Non-Callable Debt, Swaps, and Swaptions.

Assignment of the Debt and Derivative Sub-Portfolios to a specific Asset Sub-portfolio to arrive at a combined Asset, Debt and Derivative Sub-portfolio is made at S400. In S500, Computation Unit 40 calculates the financial attributes of the combined Asset, Debt and Derivative Sub-portfolio. Step S600 displays the results of the calculation of step S500.

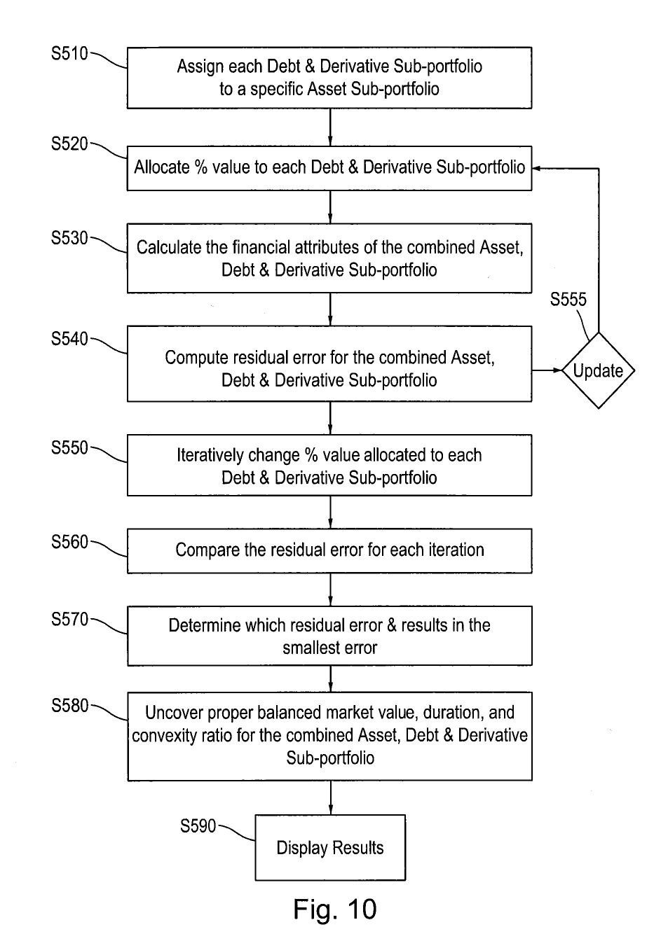

FIG. 10 is a flow diagram illustrating the assignment and allocation of a plurality of Debt and Derivative Sub-portfolios to a specific Asset Sub-portfolio and the iterative calculation of certain financial attributes. At S510, each Debt and Derivative Sub-portfolio is assigned to a specific Asset Sub-portfolio to arrive at a combined Asset, Debt and Derivative Sub-portfolio. Step S520 allocates a percentage value to each of the debts and derivatives in the combined Asset, Debt and Derivative Sub-portfolio.

Computation Unit 40 calculates the financial attributes of the combined Asset, Debt and Derivative Sub-portfolio based upon the percentage value assigned to each Debt and Derivative Sub-portfolio at S530. Step S540 computes the residual error for combined Asset, Debt and Derivative Sub-portfolio based on the calculated financial attributes. Step S555 records and updates the calculated financial attributes and the computed residual error for the specifically allocated debt and derivative sub-portfolio percentages and initializes S520 for another run.

Step S550 iteratively changes the percentage value allocated to the Debt and Derivative Sub-portfolios. The newly allocated percentage value is based upon the residual error. In other words, the Computational Unit 40 makes an educated guess as to the percentage values according to the residual error calculated in S540. Step S520 is then initiated using the newly allocated percentage values for the Debt and Derivative Sub-portfolios.

Step S560 compares the residual error for the iterations. Step S570 determines which percentage value allocation results in the smallest error. Note that Computational Unit 40 converges on the minimum residual error based upon repeatedly improved guesses.

At S580 the proper balanced market value, duration and convexity ratio is uncovered for the combined Asset, Debt and Derivative Sub-portfolio. Step S590 displays the results of the calculated minimum residual error and displays the proper balanced market value, duration and convexity ratio for the combined Asset, Debt and Derivative Sub-portfolio.

The steps of FIG. 9 and FIG. 10 may be performed on a single sub-portfolio or be performed on multiple sub-portfolios simultaneously. Furthermore, the steps can be performed on other types of financial portfolios such as those that involve illiquid securities.

Though the present invention solves for the minimum residual error of the combined asset a debt and derivative sub-portfolio resulting in no net exposure, the present invention could be modified to target a desired amount of exposure. This variation could be used to set equity at a certain level or to divide out the overall book exposure across multiple sub-portfolios.

The Debt and Derivative Allocation System 10 may be resident on any computing hardware and run on a conventional operating system to carry out the described functionality by execution of computer instructions. Operating systems may include but are not limited to Windows, Unix, Linux and Macintosh. The computer system may further implement applications that facilitate calculation including but not limited to MATLAB and/or Microsoft Excel. The artisan will readily recognize the various alternative programming languages and execution platforms that are and will become available, and the present invention is not limited to any specific execution environment.

Although the Asset, Debt and Derivative Allocation System 10 is preferably provided as software, it may alternatively be hardware, firmware, or any combination of software, hardware and firmware.

An article of manufacture wherein the program instructions that are executed to carry out the functionality described are stored on a computer readable storage medium. The medium may be of any type, including but not limited to magnetic storage media (e.g., floppy disks, hard disks), optical storage media (e.g., CD, DVD), and others.

Although the present invention has been described in considerable detail with reference to certain embodiments thereof, the invention may be variously embodied without departing from the spirit or scope of the invention. Therefore, the following claims should not be limited to the description of the embodiments contained herein in any way.

1-21. (canceled)

22. A method for dividing assets, debts, and derivatives of an original book having a particular asset market value into sub-portfolios, the method comprising:
parsing, by a computer, the assets, the debts, and the derivatives of the original book into buckets of like product classes;
splitting, by the computer, the buckets of like product classes into an asset portfolio and a debt-derivative portfolio;
calculating, by the computer, a set of financial attributes for the asset portfolio and the debt-derivative portfolio;
allocating, by the computer, the assets portfolio into a plurality of asset sub-portfolios and the debt-derivative portfolio into a plurality of debt-derivative sub-portfolios;
generating, by the computer, a plurality of combined asset-debt-derivative sub-portfolios by assigning each debt-derivative sub-portfolio to each asset sub-portfolio; and
calculating, by the computer, a set of financial attributes for each combined asset-debt-derivative sub-portfolio to produce a set of subsidiary profiles.

23. The method of claim 22, wherein the buckets of like product classes include single family mortgage backed securities and loans, multi family mortgage backed securities and loans, cash, and fed funds.

24. The method of claim 22, wherein the buckets of like product classes include short term debts, long term callable debt, long term non-callable debt, swaps, and swaptions.

25. The method of claim 22, wherein the set of financial attributes include market value, duration, and asset convexity, interest, market-to-market, key rate durations, and vega.

26. The method of claim 22, further comprising:
calculating, by the computer, residual error factors and results for the financial attributes of the asset portfolio and the debt-derivative portfolio when calculating the set of financial attributes for the asset portfolio and the debt-derivative portfolio.

27. The method of claim 22, wherein the set of financial attributes including an asset balance and a debt-derivative balance, and
wherein allocating the assets portfolio into a plurality of asset sub-portfolios and the debt-derivatives portfolio into a plurality of debt-derivative sub-portfolios is based on a predetermined number of subsidiary profiles such that the asset balance is divided equally among the plurality of asset sub-portfolios and the debt-derivative balance is divided equally among the plurality of debt-derivative sub-portfolios, and
wherein a number of combined asset-debt-derivative sub-portfolios is based on the predetermined number of subsidiary profiles.

28. The method of claim 22, further comprising:
calculating, by the computer, residual error factors and results for the financial attributes of each combined asset-debt-derivative sub-portfolio when calculating the set of financial attributes for each combined asset-debt-derivative.

29. The method of claim 28, further comprising:
minimizing, by the computer, the residual error factors and results by changing the allocation of the assets portfolio and the debt-derivative portfolio.

30. A computer program product comprising a non-transitory computer readable medium including program code stored thereon, for dividing assets, debts, and derivatives of an original book having a particular asset market value into sub-portfolios, the program code being executable to perform operations of:
parsing, the assets, the debts, and the derivatives of the original book into buckets of like product classes;
splitting the buckets of like product classes into an asset portfolio and a debt-derivative portfolio;
calculating a set of financial attributes for the asset portfolio and the debt-derivative portfolio;
allocating the assets portfolio into a plurality of asset sub-portfolios and the debt-derivative portfolio into a plurality of debt-derivative sub-portfolios;
generating a plurality of combined asset-debt-derivative sub-portfolios by assigning each debt-derivative sub-portfolio to each asset sub-portfolio; and
calculating a set of financial attributes for each combined asset-debt-derivative sub-portfolio to produce a set of subsidiary profiles.

31. The computer program product of claim 30, wherein the buckets of like product classes include single family mortgage backed securities and loans, multi family mortgage backed securities and loans, cash, and fed funds.

32. The computer program product of claim 30, wherein the buckets of like product classes include short term debts, long term callable debt, long term non-callable debt, swaps, and swaptions.

33. The computer program product of claim 30, wherein the set of financial attributes include market value, duration, and asset convexity, interest, market-to-market, key rate durations, and vega.

34. The computer program product of claim 30, further comprising:
calculating residual error factors and results for the financial attributes of the asset portfolio and the debt-derivative portfolio when calculating the set of financial attributes for the asset portfolio and the debt-derivative portfolio.

35. The computer program product of claim 30, wherein the set of financial attributes including an asset balance and a debt-derivative balance, and
wherein allocating the assets portfolio into a plurality of asset sub-portfolios and the debt-derivatives portfolio into a plurality of debt-derivative sub-portfolios is based on a predetermined number of subsidiary profiles such that the asset balance is divided equally among the plurality of asset sub-portfolios and the debt-derivative balance is divided equally among the plurality of debt-derivative sub-portfolios, and
wherein a number of combined asset-debt-derivative sub-portfolios is based on the predetermined number of subsidiary profiles.

36. The computer program product of claim 30, further comprising:
calculating residual error factors and results for the financial attributes of each combined asset-debt-derivative sub-portfolio when calculating the set of financial attributes for each combined asset-debt-derivative.

37. The computer program product of claim 36, further comprising:
minimizing the residual error factors and results by changing the allocation of the assets portfolio and the debt-derivative portfolio.

38. A method for dividing an original book of financial instruments into a subset book of financial instruments having particularly desired characteristics, the method comprising:
identifying, by a computer, a plurality of assets and a plurality of debt and derivative instruments that collectively comprise the original book;
determining, by the computer, a desired market value, a desired duration and a desired convexity for the subset book;
parsing, by the computer, the plurality of debt and derivative instruments into a plurality of buckets of like instruments;
determining, by the computer, a market value, a duration and a convexity for each of the plurality of buckets;
allocating, by the computer, a subset of assets of the original book to the subset book;
further allocating, by the computer, a percentage of each bucket to the subset book so that a resulting subset book has, subject to a maximum error, the desired market value, the desired duration and the desired convexity.

39. The method according to claim 38, wherein the desired market value, the desired duration and the desired convexity are determined so as to match that of the original book.

40. A computer program product comprising a non-transitory computer readable medium including program code stored thereon, for dividing an original book of financial instruments into a subset book of financial instruments having particularly desired characteristics, the program code being executable to perform operations of:
identifying, by a computer, a plurality of assets and a plurality of debt and derivative instruments that collectively comprise the original book;
determining, by the computer, a desired market value, a desired duration and a desired convexity for the subset book;
parsing, by the computer, the plurality of debt and derivative instruments into a plurality of buckets of like instruments;
determining, by the computer, a market value, a duration and a convexity for each of the plurality of buckets;
allocating, by the computer, a subset of assets of the original book to the subset book;
further allocating, by the computer, a percentage of each bucket to the subset book so that a resulting subset book has, subject to a maximum error, the desired market value, the desired duration and the desired convexity.

41. The computer program product according to claim 40, wherein the desired market value, the desired duration and the desired convexity are determined so as to match that of the original book.
